(19) United States
(12) Patent Application Publication
(10) Pub. No.: US 2026/0009204 A1
(43) Pub. Date: Jan. 8, 2026

(54) WORK MACHINE AND METHOD FOR CONTROLLING WORK MACHINE

(71) Applicant: KOMATSU LTD., Tokyo (JP)

(72) Inventor: Hiroki NAGASAKI, Tokyo (JP)

(21) Appl. No.: 18/994,212

(22) PCT Filed: Aug. 21, 2023
(86) PCT No.: PCT/JP2023/030024

§ 371 Date: Jan. 14, 2025

(30) Foreign Application Priority Data
Oct. 25, 2022 (JP) 2022-170735

(51) Int. Cl. E02F 9/20

(52) U.S. Cl. CPC E02F 9/2045; E02F 9/2087

(57) ABSTRACT

A work machine includes a traveling wheel, a steering actuator, and a controller. The steering actuator changes the steering angle of the traveling wheel from a neutral angle to the left or right. The controller controls the steering actuator. The controller executes an automatic steering control to control the steering angle by the steering actuator so that the work machine travels along a predetermined target path. The controller determines a traveling direction status indicating the forward or rearward traveling direction of the work machine. The controller sets the steering angle to the neutral angle upon determining that the traveling direction status is unknown during the automatic steering control.

### CROSS-REFERENCE TO RELATED APPLICATIONS

This application is a U.S. National stage application of International Application No. PCT/JP2023/030024, filed on Aug. 21, 2023. This U.S. National stage application claims priority under 35 U.S.C. § 119 (a) to Japanese Patent Application No. 2022-170735, filed in Japan on Oct. 25, 2022, the entire contents of which are hereby incorporated herein by reference.

### BACKGROUND

### Technical Field

The present disclosure relates to a work machine and a method for controlling the work machine.

### Background Information

Among work machines, there is a work machine that performs an automatic steering control so that the work machine moves along a predetermined target path. For example, in Japanese Patent Laid-open No. 2021-054269, a travel route is generated based on the position and bearing of a motor grader and the traveling direction of the motor grader. A steering mechanism is controlled so that the motor grader travels along the travel route.

### SUMMARY

In the abovementioned automatic steering control, when the work machine deviates from the travel route to the right, a controller steers the front wheels to the left during forward travel and steers the front wheels to the right during rearward travel, thereby correcting the direction of the work machine. When the work machine deviates from the travel route to the left, the controller steers the front wheels to the right during forward travel and steers the front wheels to the left during rearward travel, thereby correcting the direction of the work machine. Consequently, the work machine is automatically controlled so as to travel along the travel path.

The forward or rearward traveling direction of the work machine is determined, for example, from a command signal for instructing the forward or rearward traveling direction of the work machine. For example, the work machine includes a shift lever that is operated in order to switch between forward travel and rearward travel of the work machine. The controller detects the position of the shift lever and determines the forward or rearward traveling direction of the work machine in accordance with the position of the shift lever.

However, in a work machine, there may be a case in which the work machine continues to travel forward due to inertia even if the shift lever is switched from the forward travel position to the rearward travel position. In this case, even if the controller determines that the traveling direction of the work machine is rearward travel based on the position of the shift lever, the work machine is actually traveling forward. As a result, the traveling wheels may be steered in a direction opposite to the proper direction in the automatic steering control and the work machine may wander. An object of the present disclosure is to suppress wandering of the work machine when the forward travel and rearward travel are switched during the automatic steering control.

A work machine according to an aspect of the present disclosure includes a traveling wheel, a steering actuator, and a controller. The steering actuator changes the steering angle of the traveling wheel from a neutral angle to the left or right. The controller controls the steering actuator. The controller executes an automatic steering control for controlling the steering angle by the steering actuator so that the work machine travels along a predetermined target path. The controller determines a traveling direction status that indicates the forward or rearward traveling direction of the work machine. The controller sets the steering angle to the neutral angle when it is determined that the traveling direction status is unknown during the automatic steering control.

A method for controlling a work machine according to another aspect of the present disclosure includes: executing an automatic steering control for controlling the steering angle of the work machine so that the work machine travels along a predetermined target path; determining a traveling direction status that indicates the forward or rearward traveling direction of the work machine; and setting the steering angle to a neutral angle when it is determined that the traveling direction status is unknown during the automatic steering control.

A method for controlling a work machine according to a further aspect of the present disclosure is a method for controlling the work machine, the method comprising: executing an automatic steering control for controlling the steering angle of the work machine so that the work machine travels along a predetermined target path; determining a traveling direction status that indicates the forward or rearward traveling direction of the work machine; and setting the steering angle to a neutral angle when the forward or rearward traveling direction of the work machine is switched during the automatic steering control.

According to the present disclosure, the steering angle is set to the neutral angle when it is determined that the traveling direction status that indicates the forward or rearward traveling direction of the work machine is unknown during the automatic steering control. Consequently, the work machine is prevented from being steered in a direction opposite to the proper direction. As a result, wandering of the work machine when the forward travel and rearward travel of the work machine are switched is suppressed during the automatic steering control.

### BRIEF DESCRIPTION OF DRAWINGS

FIG. 1 is a perspective view of a work machine according to an embodiment.

FIG. 2 is a side view of the work machine.

FIG. 3 is a schematic view of a configuration of the work machine.

FIG. 4 is a top view of a front part of the work machine.

FIG. 5 illustrates an example of travel of the work machine based on an operation on a steering operating member.

FIG. 6 illustrates an automatic control of the steering angle in a straight travel maintaining mode.

FIG. 7 is a flow chart illustrating processing for determining a target angle in accordance with the traveling direction status.

FIG. 8 is a block diagram of determination logic of the traveling direction status.

### DETAILED DESCRIPTION OF EMBODIMENT(S)

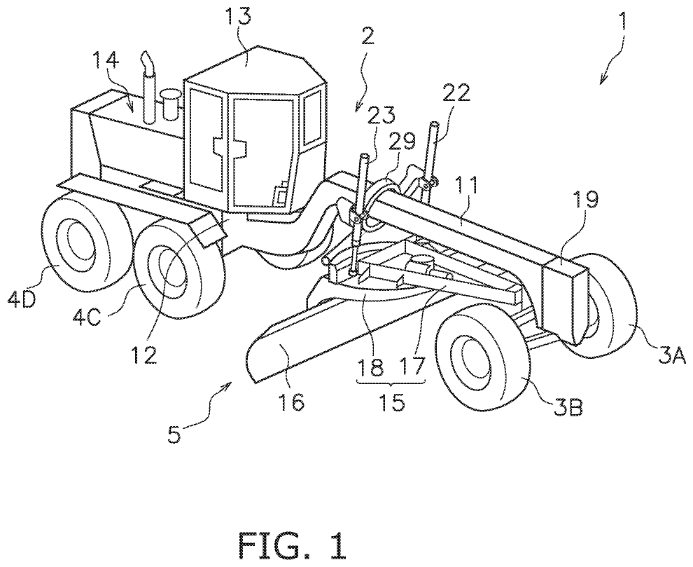

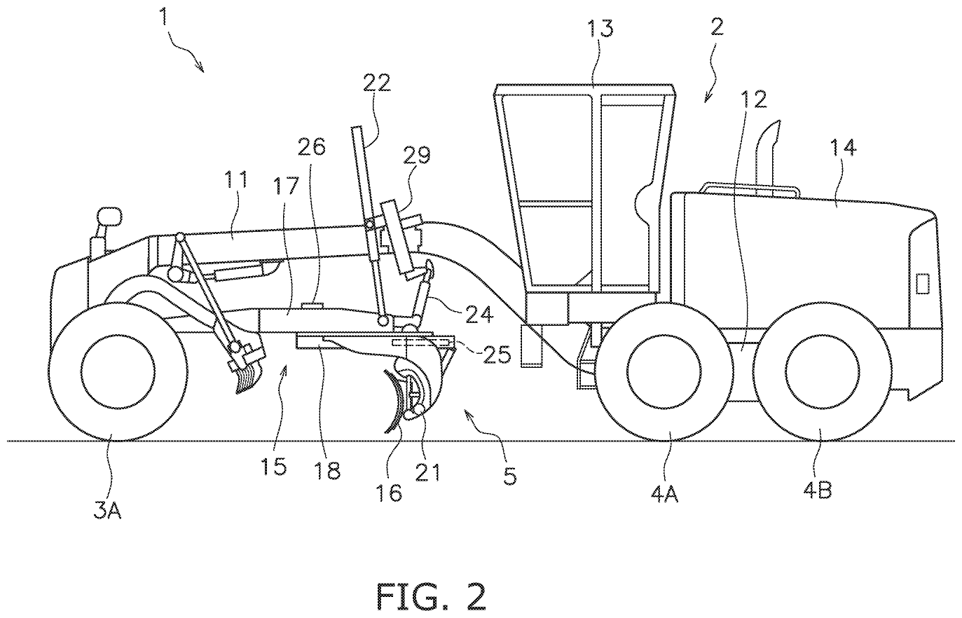

An embodiment of the present invention will be described below with reference to the drawings. FIG. 1 is a perspective view of a work machine 1 according to the embodiment. FIG. 2 is a side view of the work machine 1. As illustrated in FIG. 1, the work machine 1 includes a vehicle body 2, traveling wheels 3A, 3B, and 4A-4D, and a work implement 5. The vehicle body 2 includes a front frame 11, a rear frame, 12, a cab 13, and a power chamber 14. The traveling wheels 3A, 3B, and 4A-4D include front wheels 3A and 3B and rear wheels 4A-4D. The work machine 1 turns to the left and right by steering the front wheels 3A and 3B to the left or right.

The rear frame 12 is connected to the front frame 11. The front frame 11 is able to articulate to the left and right with respect to the rear frame 12. In the following explanation, the front, rear, left, and right directions signify the front, rear, left, and right directions of the vehicle body 2 while the articulate angle is zero, that is while the front frame 11 and the rear frame 12 are straight.

The cab 13 and the power chamber 14 are disposed on the rear frame 12. An unillustrated operator's seat is disposed in the cab 13. The cab 13 is disposed to the rear of the power chamber 14. The front frame 11 extends toward the front from the rear frame 12. The front wheels 3A and 3B are attached to the front frame 11. The rear wheels 4A-4D are attached to the rear frame 12.

The work implement 5 is movably connected to the vehicle body 2. The work implement 5 includes a supporting member 15 and a blade 16. The supporting member 15 is movably connected to the vehicle body 2. The supporting member 15 supports the blade 16. The supporting member 15 includes a drawbar 17 and a circle 18. The drawbar 17 is disposed below the front frame 11.

The drawbar 17 is connected to a front part 19 of the front frame 11. The drawbar 17 extends toward the rear from the front part 19 of the front frame 11. The drawbar 17 is swingably supported at least in the up-down direction and the left-right direction of the vehicle body 2 with respect to the front frame 11. For example, the front part 19 includes a ball joint. The drawbar 17 is rotatably connected to the front frame 11 via the ball joint.

The circle 18 is connected to a rear part of the drawbar 17. The circle 18 is supported to be rotatable with respect to the drawbar 17. The blade 16 is connected to the circle 18. The blade 16 is supported by the drawbar 17 via the circle 18. As illustrated in FIG. 2, the blade 16 is supported by the circle 18 to be rotatable about a tilt shaft 21. The tilt shaft 21 extends in the left-right direction.

The work machine 1 includes a plurality of actuators 22-26 for changing the orientation of the work implement 5. The plurality of actuators 22-26 include a plurality of hydraulic cylinders 22-25. The plurality of hydraulic cylinders 22-25 are connected to the work implement 5. The plurality of hydraulic cylinders 22-25 extend and contract due to hydraulic pressure. The plurality of hydraulic cylinders 22-25 change the orientation of the work implement 5 with respect to the vehicle body 2 by extending and contracting. In the following explanation, the extension and contraction of the hydraulic cylinders is referred to as a “stroke motion.”

Specifically, the plurality of hydraulic cylinders 22-25 includes a left lift cylinder 22, a right lift cylinder 23, a drawbar shift cylinder 24, and a blade tilt cylinder 25. The left lift cylinder 22 and the right lift cylinder 23 are disposed away from each other in the left-right direction. The left lift cylinder 22 and the right lift cylinder 23 are connected to the drawbar 17. The left lift cylinder 22 and the right lift cylinder 23 are connected to the front frame 11 via a lifter bracket 29. The drawbar 17 swings up and down due to the stroke motions of the left lift cylinder 22 and the right lift cylinder 23. As a result, the blade 16 moves up and down.

The drawbar shift cylinder 24 is coupled to the drawbar 17 and the front frame 11. The drawbar shift cylinder 24 is connected to the front frame 11 via the lifter bracket 29. The drawbar shift cylinder 24 extends diagonally downward from the front frame 11 toward the drawbar 17. The drawbar 17 swings left and right due to the stroke motions of the drawbar shift cylinder 24. The blade tilt cylinder 25 is connected to the circle 18 and the blade 16. The blade 16 rotates about the tilt shaft 21 due to the stroke motions of the blade tilt cylinder 25.

The plurality of actuators 22-26 includes a rotation actuator 26. The rotation actuator 26 is connected to the drawbar 17 and the circle 18. The rotation actuator 26 causes the circle 18 to rotate with respect to the drawbar 17. Consequently, the blade 16 rotates about a rotating axis that extends in the up-down direction.

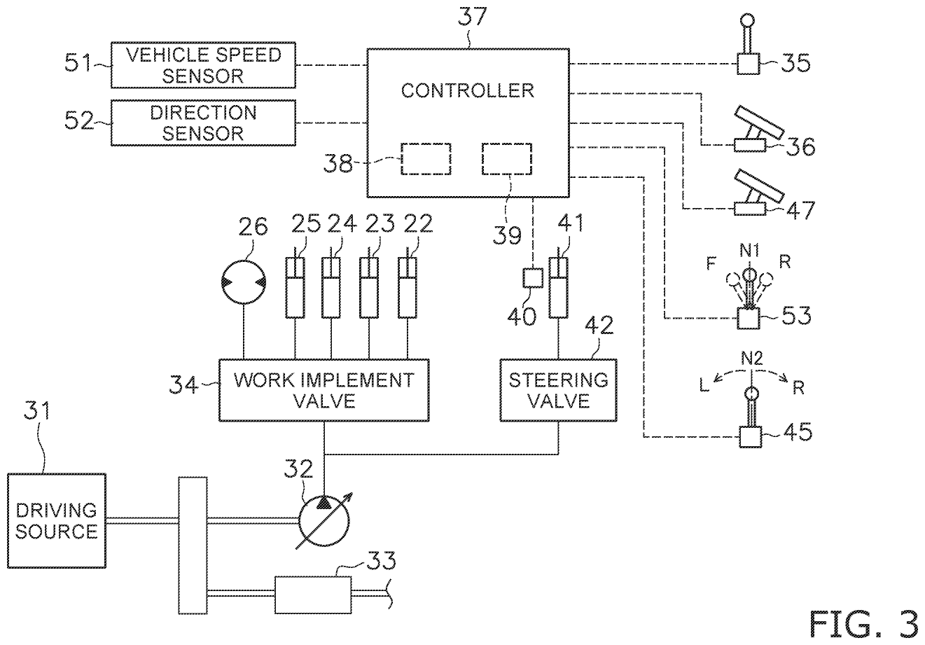

FIG. 3 is a schematic view of a configuration of the work machine 1. As illustrated in FIG. 3, the work machine 1 includes a driving source 31, a hydraulic pump 32, a power transmission device 33, and a work implement valve 34. The driving source 31 is, for example, an internal combustion engine. Alternatively, the driving source 31 may be an electric motor or a hybrid of an internal combustion engine and an electric motor. The hydraulic pump 32 is driven by the driving source 31 thereby discharging hydraulic fluid.

The work implement valve 34 is connected to the hydraulic pump 32 and the plurality of hydraulic cylinders 22-25 via a hydraulic circuit. The work implement valve 34 includes a plurality of valves connected to each of the plurality of hydraulic cylinders 22-25. The work implement valve 34 controls the flow rate of the hydraulic fluid supplied from the hydraulic pump 32 to the plurality of hydraulic cylinder 22-25. The work implement valve 34 is, for example, an electromagnetic proportional control valve. Alternatively, the work implement valve 34 may be a hydraulic pilot-type proportional control valve.

In the present embodiment, the rotation actuator 26 is a hydraulic motor. The work implement valve 34 is connected to the hydraulic pump 32 and the rotation actuator 26 via the hydraulic circuit. The work implement control valve 34 controls the flow rate of hydraulic fluid supplied from the hydraulic pump 32 to the rotation actuator 26. The rotation actuator 26 may be an electric motor.

The power transmission device 33 transmits the driving power from the driving source 31 to the rear wheels 4A-4D. The power transmission device 33 may include a torque converter and/or a plurality of speed change gears. Alternatively, the power transmission device 33 may be transmission of another type such as a hydraulic static transmission (HST) or a hydraulic mechanical transmission (HMT).

The work machine 1 includes a work implement operating member 35, a shift operating member 53, an accelerator operating member 36, a brake operating member 47, and a controller 37. The work implement operating member 35 is operable by an operator in order to change the orientation of the work implement 5. The work implement operating member 35 includes, for example, a plurality of operating levers. Alternatively, the work implement operating member 35 may be another member such as a switch or a touch screen. The work implement operating member 35 outputs a signal that indicates the operations on the work implement operating member 35 by the operator.

The shift operating member 53 is operable by the operator for instructing the forward or rearward traveling direction of the work machine 1. The shift operating member 53 includes, for example, a shift lever. Alternatively, the shift operating member 53 may be another member such as a switch or a touch screen. The shift operating member 53 is operable between a forward travel position (F), a rearward travel position (R), and a neutral position (N1). The shift operating member 53 outputs a signal indicating the operating position of the shift operating member 53.

The accelerator operating member 36 is operable by an operator for causing the work machine 1 to travel. The accelerator operating member 36 includes, for example, an accelerator pedal. Alternatively, the accelerator operating member 36 may be another member such as a switch or a touch screen. The accelerator operating member 36 outputs a signal that indicates the operation on the accelerator operating member 36 by the operator. The brake operating member 47 is operable by the operator for braking the work machine 1. The brake operating member 47 includes, for example, a brake pedal.

The controller 37 switches between forward travel and rearward travel of the work machine 1 by controlling the power transmission device 33 in response to the operation of the shift operating member 53. Alternatively, the shift operating member 53 may be mechanically connected to the power transmission device 33. The actions of the shift operating member 53 may be mechanically transmitted to the power transmission device 33 whereby the gears for forward travel and rearward travel of the power transmission device 33 may be switched.

The controller 37 causes the work machine 1 to travel by controlling the driving source 31 and the power transmission device 33 in response to the operation of the accelerator operating member 36. The controller 37 actuates the work implement 5 by controlling the hydraulic pump 32 and the work implement valve 34 in response to the operation of the work implement operating member 35.

The controller 37 includes a storage device 38 and a processor 39. The processor 39 is, for example, a CPU and executes a program for controlling the work machine 1. The storage device 38 includes a memory such as a RAM or a ROM, and an auxiliary storage device such as an SSD or an HDD. The storage device 38 stores programs and data for controlling the work machine 1.

The work machine 1 includes a vehicle speed sensor 51. The vehicle speed sensor 51 detects the vehicle speed of the work machine 1. The vehicle speed sensor 51 outputs a signal that indicates the vehicle speed of the work machine 1. For example, the vehicle speed sensor 51 may detect the output rotation speed of the power transmission device 33. The output rotation speed of the power transmission device 33 corresponds to the vehicle speed of the work machine 1. Alternatively, the vehicle speed sensor 51 may be a global navigation satellite system (GNSS) receiver such as a global positioning system (GPS) device.

The work machine 1 includes a direction sensor 52. The direction sensor 52 detects the traveling direction of the vehicle body 2. The direction sensor 52 outputs a direction signal indicating the traveling direction of the vehicle body 2. The controller 37 acquires the traveling direction of the vehicle body 2 from the direction signal from the direction sensor 52. The traveling direction of the vehicle body 2 is represented, for example, by the yaw angle of the vehicle body 2. The direction sensor 52 is, for example, an inertial measurement device (IMU). The controller 37 calculates the traveling direction of the vehicle body 2 based on the acceleration and the angular speed of the vehicle body 2. Alternatively, the direction sensor 52 may be a GNSS receiver. The controller 37 may acquire the traveling direction of the vehicle body 2 from a change in the position of the work machine 1 detected by the direction sensor 52.

As illustrated in FIG. 3, the work machine 1 includes a steering angle sensor 40, a steering actuator 41, and a steering valve 42. The steering actuator 41 is a hydraulic cylinder. The steering actuator 41 extends and contracts with hydraulic fluid from the hydraulic pump 32. The steering actuator 41 steers the front wheels 3A and 3B by extending and contracting.

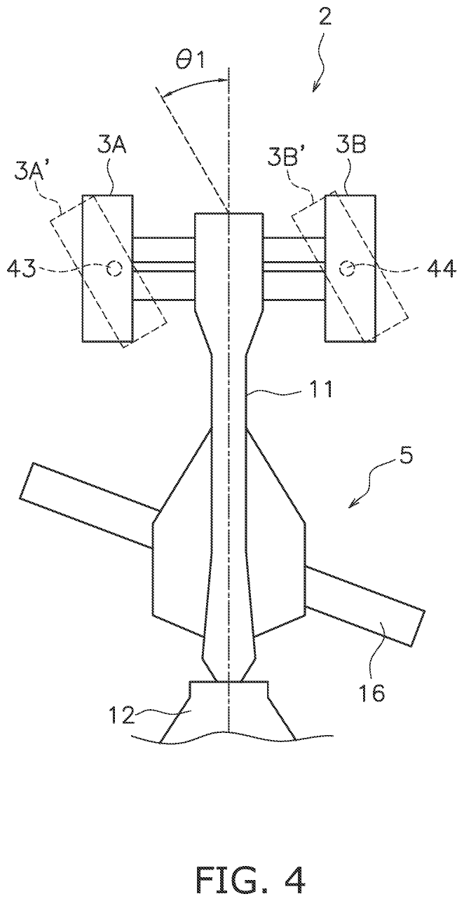

FIG. 4 is a top view of the front part of the work machine 1. As illustrated in FIG. 4, the front wheels 3A and 3B include a first front wheel 3A and a second front wheel 3B. The first front wheel 3A and the second front wheel 3B are disposed away from each other in the left-right direction. The first front wheel 3A is supported by the front frame 11 to be rotatable about a first steering shaft 43. The second front wheel 3B is supported by the front frame 11 to be rotatable about a second steering shaft 44. The first steering shaft 43 and the second steering shaft 44 extend in the up-down direction.

The steering actuator 41 is connected to the front wheels 3A and 3B and the front frame 11. The steering actuator 41 changes a steering angle θ1 of the front wheels 3A and 3B from a predetermined neutral angle to the left or right. As illustrated in FIG. 4, the steering angle θ1 is the angle that the front wheels 3A and 3B face with respect to the front-back direction of the work machine 1. The front-back direction of the work machine 1 signifies the front-back direction of the front frame 11. However, the front-back direction of the work machine 1 may signify the front-back direction of the rear frame 12.

The neutral angle is a steering angle θ1 of zero degrees. Therefore, when the steering angle θ1 is the neutral angle, the front wheels 3A and 3B are facing straight forward in the work machine 1. In FIG. 4, 3A′ indicates the first front wheel 3 that has been steered from the neutral angle to the left by the steering angle θ1. 3B′ indicates the second front wheel 3B that has been steered from the neutral angle to the left by the steering angle θ1.

The steering valve 42 is connected through the hydraulic circuit to the hydraulic pump 32 and the steering actuator 41. The steering valve 42 controls the flow rate of hydraulic fluid supplied from the hydraulic pump 32 to the steering actuator 41.

The steering angle sensor 40 detects the steering angle θ1. The steering angle sensor 40 outputs an angle signal indicating the steering angle θ1. The controller 37 acquires the current steering angle θ1 from the angle signal from the steering angle sensor 40. The steering angle sensor 40 detects, for example, the stroke amount of the steering actuator 41. The steering angle θ1 is calculated from the stroke amount of the steering actuator 41. Alternatively, the steering angle sensor 40 may detect the steering angle θ1 directly.

As illustrated in FIG. 3, the work machine 1 includes a steering operating member 45. The steering operating member 45 is operable by the operator for changing the steering angle θ1 of the front wheels 3A and 3B to the left or right. The steering operating member 45 is operable from a neutral position (N2) to a left steering range (L) and a right steering range (R). The steering operating member 45 is, for example, a lever. Alternatively, the steering operating member 45 may be another member such as a steering wheel or a switch. The steering operating member 45 outputs a signal that indicates an operation on the steering operating member 45 by the operator.

The controller 37 operates the steering actuator 41 by controlling the steering valve 42 in accordance with the operation of the steering operating member 45. Consequently, the steering angle θ1 of the front wheels 3A and 3B is changed to the left or right whereby the work machine 1 turns to the left or right.

Next, the automatic steering control for automatically controlling the steering angle θ1 will be explained. In the automatic steering control, the controller 37 controls the steering actuator 41 so that the steering angle θ1 becomes a predetermined target angle. The automatic control includes a center return mode and a straight travel maintaining mode.

In the center return mode, the controller 37 controls the steering actuator 41 so that the steering angle θ1 automatically returns to the neutral angle when the steering operating member 45 is returned from the left steering range (L) to the neutral position (N2) or when the steering operating member 45 is returned from the right steering range (R) to the neutral position (N2).

For example, when the steering angle θ1 is a predetermined angle to the left, the controller 37 controls the steering actuator 41 so that the steering angle θ1 returns from the predetermined angle to the left to the neutral angle when the steering operating member 45 is returned to the neutral position (N2). When the steering angle θ1 is a predetermined angle to the right, the controller 37 controls the steering actuator 41 so that the steering angle θ1 returns from the predetermined angle to the right to the neutral angle when the steering operating member 45 is returned to the neutral position (N2).

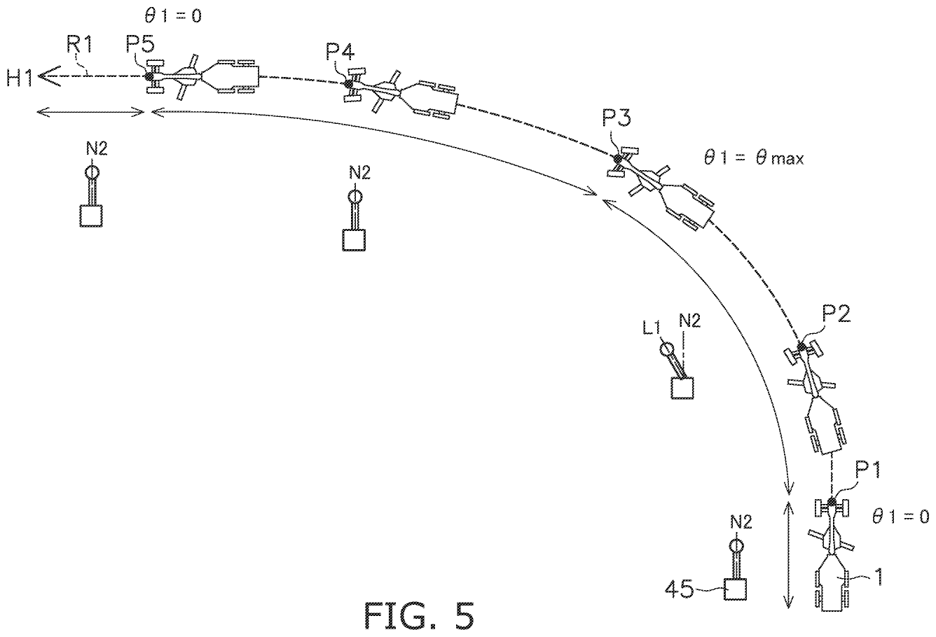

FIG. 5 illustrates an example of travel of the work machine 1 due to an operation on the steering operating member 45. As illustrated in FIG. 5, the steering operating member 45 is positioned at the neutral position (N2) while the work machine 1 is at the point P1. The steering angle θ1 is a neutral angle and the work machine 1 travels straight forward. At the point P2, the steering angle θ1 of the front wheels 3A and 3B begins to change from the neutral angle to the left when the operator operates the steering operating member 45 by the operating amount L1 within the left operating range. Consequently, the work machine 1 turns to the left.

When the operator holds the steering operating member 45 at the operating amount L1 from the point P2 to the point P3, the steering angle θ1 of the front wheels 3A and 3B continues to increase up to a maximum steering angle θmax to the left. Consequently, the work machine 1 continues to turn to the left.

When the operator returns the steering operating member 45 to the neutral position (N2) at the point P3, the steering angle θ1 of the front wheels 3A and 3B decreases from the maximum steering angle θmax toward the neutral angle due to the center return mode. At the point P5, the steering angle θ1 of the front wheels 3A and 3B then returns to the neutral angle.

In the straight travel maintaining mode, the controller 37 controls the steering angle θ1 so that the work machine 1 travels along a linear target travel path. Specifically, the controller 37 controls the steering angle θ1 so that the traveling direction of the vehicle body 2 is held in the target direction. For example, the controller 37 determines the traveling direction (H1) of the vehicle body 2 when the steering angle θ1 has returned to the neutral angle at point P5, as the target direction as illustrated in FIG. 5. The controller 37 then controls the steering actuator 41 so that the traveling direction of the vehicle body 2 is held at the target direction H1. Consequently, the work machine 1 moves along the linear target path R1 that extends in the target direction H1.

Specifically, the controller 37 determines the target angle of the steering angle θ1 based on the difference between the current traveling direction of the vehicle body 2 and the target direction H1. The controller 37 controls the steering actuator 41 so that the steering angle θ1 becomes the target angle. For example, the controller 37 determines the target angle of the steering angle θ1 by multiplying the difference between the current traveling direction of the vehicle body 2 and the target direction H1 by a predetermined gain. The controller 37 controls the steering actuator 41 so that the steering angle θ1 is held at the target angle by feedback control.

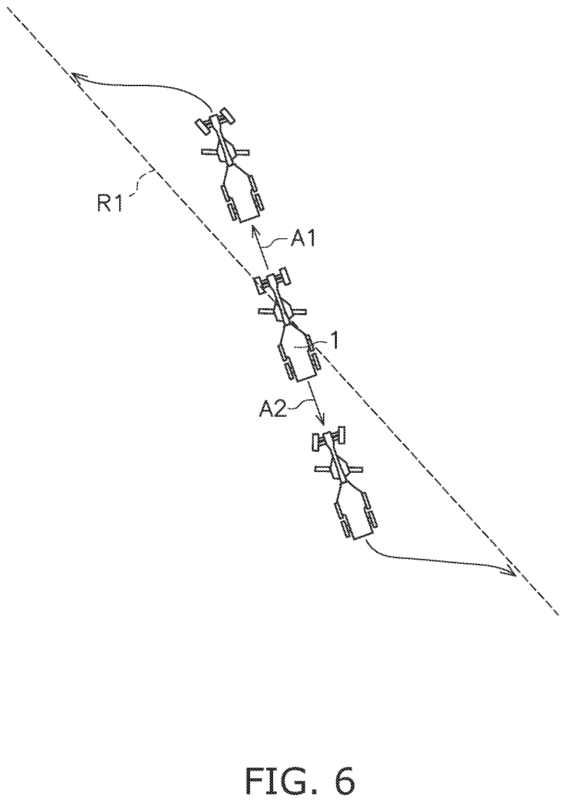

When the vehicle body 2 is traveling rearward in the straight travel maintaining mode, the controller 37 reverses the target angle of the steering angle θ1 to the left or right with respect to when the vehicle body 2 is traveling forward. For example, as illustrated in FIG. 6, when the work machine 1 is traveling forward, as indicated by arrow A1, while the direction of the work machine 1 is deviated to the right from the target path R1, the controller 37 determines the target angle to be an angle further to the left than the neutral angle. When the work machine 1 is traveling rearward, as indicated by arrow A2, while the direction of the work machine 1 is deviated to the right from the target path R1, the controller 37 determines the target angle to be an angle further to the right than the neutral angle.

In contrast, when the work machine 1 is traveling forward while the direction of the work machine 1 is deviated to the left from the target path R1, the controller 37 determines the target angle to be an angle further to the right than the neutral angle. When the work machine 1 is traveling rearward while the direction of the work machine 1 is deviated to the left from the target path R1, the controller 37 determines the target angle to be an angle further to the left than the neutral angle. That is, the controller 37 evaluates the traveling direction status of the vehicle body 2 and determines the target angle in accordance with the traveling direction status. The traveling direction status indicates the forward or rearward traveling direction of the work machine 1.

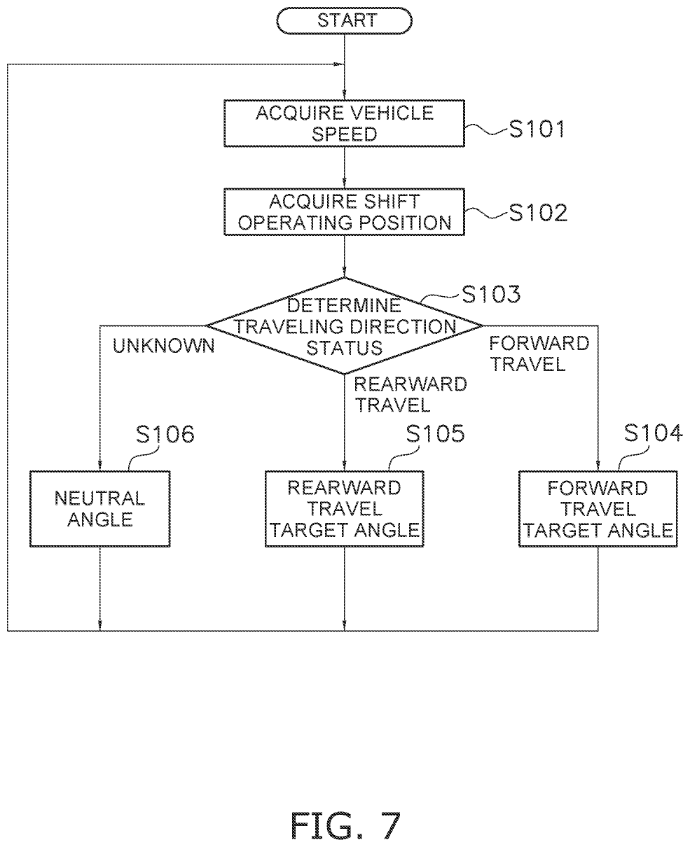

FIG. 7 is a flow chart illustrating processing for determining the target angle in accordance with the traveling direction status. As illustrated in step S101 in FIG. 7, the controller 37 acquires the vehicle speed. The controller 37 acquires the vehicle speed from a signal from the vehicle speed sensor 51. In step S102, the controller 37 acquires the shift operating position. The shift operating position is the operating position of the shift operating member 53. The controller 37 acquires the shift operating position from a signal from the shift operating member 53. The controller 37 acquires any of the forward travel position (F), the rearward travel position (R), or the neutral position (N2) as the shift operating position.

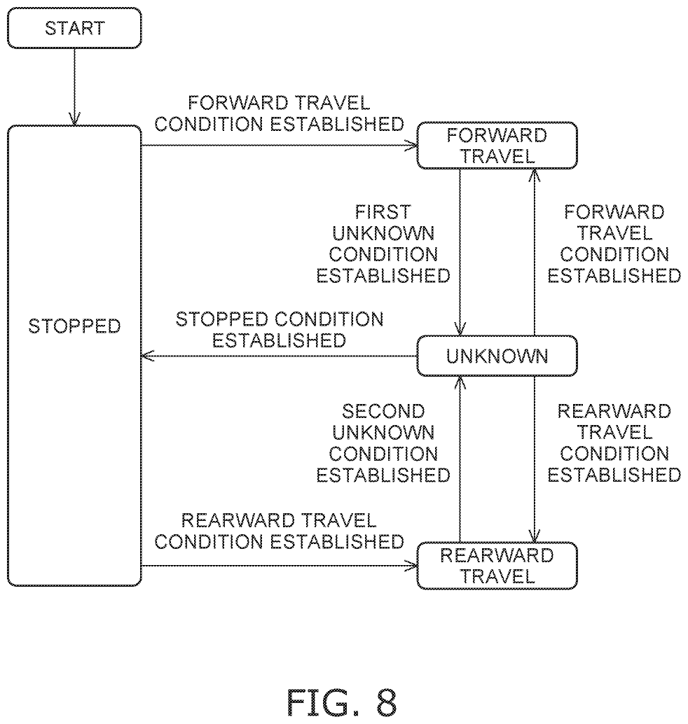

In step S103, the controller 37 determines the traveling direction status. The controller 36 determines the traveling direction status based on the vehicle speed and the shift operating position. FIG. 8 is a block diagram of determination logic of the traveling direction status. As illustrated in FIG. 8, the traveling direction status includes “stopped,” “forward travel,” “rearward travel,” and “unknown.”

As illustrated in FIG. 8, in the initial state, the traveling direction status is “stopped.” The controller 37 determines that the traveling direction status is “forward travel” when a forward travel condition is established while the traveling direction status is “stopped.” The forward travel condition includes the shift operating position being the forward travel position (F).

The controller 37 determines that the traveling direction status is “rearward travel” when a rearward travel condition is established while the traveling direction status is “stopped.” The rearward travel condition includes the shift operating position being the rearward travel position (R).

The controller 37 determines that the traveling direction status is “unknown” when a first unknown condition is established while the traveling direction status is “forward travel.” The first unknown condition includes the shift operating position being in a position other than the forward travel position (F) and the vehicle speed being less than a first threshold. That is, the first unknown condition includes the shift operating position being in the rearward travel position (R) or the neutral position (N2) and the vehicle speed being less than the first threshold. The first threshold indicates, for example, a speed that is so slow that an accurate determination of the forward or rearward traveling direction of the work machine 1 is not possible.

The controller 37 determines that the traveling direction status is “unknown” when a second unknown condition is established while the traveling direction status is “rearward travel.” The second unknown condition includes the shift operating position being in a position other than the rearward travel position (R) and the vehicle speed being less than a second threshold. That is, the second unknown condition includes the shift operating position being in the forward travel position (F) or the neutral position (N2) and the vehicle speed being less than the second threshold. The second threshold may be the same as the first threshold. The second threshold may differ from the first threshold. The second threshold indicates, for example, a speed that is so slow that an accurate determination of the forward or rearward traveling direction of the work machine 1 is not possible.

The controller 37 determines that the traveling direction status is “forward travel” when the forward travel condition is established while the traveling direction status is “unknown.” The controller 37 determines that the traveling direction status is “rearward travel” when a rearward travel condition is established while the traveling direction status is “unknown.” The controller 37 determines that the traveling direction status is “stopped” when a stopped condition is established while the traveling direction status is “unknown.” The stopped condition includes a state in which the vehicle speed is less than a third threshold continuing for a predetermined time period or longer. The third threshold is, for example, a speed that is so slow that it seems that the work machine 1 is stopped. As described above, the controller 37 determines the traveling direction status to be any of “stopped,” “forward travel,” “rearward travel,” or “unknown.”

As illustrated in step S104 in FIG. 7, when the traveling direction status is forward travel in the straight travel maintaining mode, the controller 37 determines the target angle of the steering angle θ1 to be a forward travel target angle. The forward target angle is the abovementioned target angle of the steering angle θ during forward travel. When the traveling direction status is rearward travel in the straight travel maintaining mode in step S105, the controller 37 determines the target angle of the steering angle θ1 to be a rearward travel target angle. The rearward target angle is the target angle of the steering angle θ during rearward travel. The rearward travel target angle is the angle that is opposite to the left or right of the forward travel target angle.

When the traveling direction status is unknown in the straight travel maintaining mode, in step S106, the controller 37 determines the target angle of the steering angle θ1 to be the neutral angle. The controller 37 repeatedly executes the above processing while executing the straight travel maintaining mode. Therefore, when the controller 37 determines that the traveling direction status is unknown, the controller 37 sets the steering angle to the neutral angle and thereafter maintains the steering angle at the neutral angle until the traveling direction status is determined as forward travel or rearward travel.

The controller 37 changes the steering angle from the neutral angle to the forward travel target angle when the traveling direction status has changed from unknown to forward travel. The controller 37 changes the steering angle from the neutral angle to the rearward travel target angle when the traveling direction status has changed from unknown to rearward travel.

In the work machine 1 according to the present embodiment discussed above, the steering angle is set to the neutral angle when the traveling direction status is determined as unknown during the automatic steering control. Consequently, the work machine 1 is prevented from being steered in a direction opposite to the proper direction. As a result, wandering of the work machine 1 when the forward travel and rearward travel are switched is suppressed during the automatic steering control.

Although an embodiment of the present invention has been described so far, the present invention is not limited to the above embodiment and various modifications may be made within the scope of the invention.

The work machine 1 is not limited to a motor grader and may be another work machine such as a wheel loader, a dump truck, or a forklift. The number of the steering actuator 41 is not limited to one and there may be two or more. The steering actuator 41 is not limited to a hydraulic cylinder and may be a hydraulic motor or an electric motor. The work machine 1 turns to the left or right by steering the front wheels to the left or right in the abovementioned embodiment. However, the work machine 1 may turn to the left or right by steering the rear wheels to the left or right.

The process of the automatic steering control may be changed and is not limited to that described in the above embodiment. For example, the controller 37 may maintain the steering angle at the neutral angle until a predetermined time period has elapsed when the traveling direction status is determined as unknown. The controller 37 may set the steering angle as the neutral angle when the forward or rearward traveling direction of the work machine 1 is switched regardless of whether the traveling direction status is unknown. The controller 37 may maintain the steering angle at the neutral angle until a predetermined time period has elapsed when the forward or rearward traveling direction of the work machine 1 is switched.

The target direction H1 is not limited to the traveling direction of the vehicle body 2 when the steering angle θ1 has been returned to the neutral angle, and may be determined with another method. For example, the target direction H1 may be the traveling direction of the vehicle body 2 when the steering operating member has been returned to the neutral position (N2). Alternatively, the target direction H1 may be input by an operator. The target direction H1 may be input from an external computer.

In the above embodiment, the command signal for instructing the forward or rearward traveling direction of the work machine 1 is a signal that indicates the shift operating position from the shift operating member 53. However, the command signal for instructing the forward or rearward traveling direction of the work machine 1 may be another signal. For example, when the controller 37 is automatically controlling the traveling of the work machine 1, the command signal for instructing the forward or rearward traveling direction of the work machine 1 may be generated by the controller 37.

While the target path R1 in the above embodiment is defined by the target direction H1 in the straight travel maintaining mode, the target path R1 may be set with another method. For example, the target path R1 may be any route input by the operator. The target path R1 may be any route input by an external computer.

According to the present disclosure, wandering of the work machine when the forward travel and rearward travel are switched is suppressed during the automatic steering control.

1. A work machine comprising:
a traveling wheel;
a steering actuator that changes a steering angle of the traveling wheel from a neutral angle to leftward or rightward; and
a controller that controls the steering actuator, the controller being configured to
execute an automatic steering control to control the steering angle by the steering actuator so that the work machine travels along a predetermined target path,
determine a traveling direction status indicating a forward or rearward traveling direction of the work machine, and
set the steering angle to the neutral angle upon determining that the traveling direction status is unknown during the automatic steering control.

2. The work machine according to claim 1, wherein
the controller is configured to
acquire a command signal instructing the forward or rearward traveling direction of the work machine,
acquire a vehicle speed of the work machine, and
determine the traveling direction status based on the command signal and the vehicle speed.

3. The work machine according to claim 2, wherein
in a case in which the traveling direction status is forward travel, the controller is configured to determine that the traveling direction status is unknown when the command signal indicates an instruction other than forward travel and the vehicle speed is less than a predetermined threshold.

4. The work machine according to claim 2, wherein
in a case in which the traveling direction status is rearward travel, the controller is configured to determine that the traveling direction status is unknown when the command signal indicates an instruction other than rearward travel and the vehicle speed is less than a predetermined threshold.

5. The work machine according to claim 1, wherein
the controller is configured to maintain the steering angle at the neutral angle until the traveling direction status is determined as forward travel or rearward travel.

6. The work machine according to claim 1, wherein
the controller is configured to
acquire a command signal instructing the forward or rearward traveling direction of the work machine, and
maintain the steering angle at the neutral angle until a predetermined time period has elapsed in a case in which the controller determines that the traveling direction status is unknown when a switch of the traveling direction is instructed based on the command signal.

7. A method for controlling a work machine, the method comprising:
executing an automatic steering control to control a steering angle of the work machine so that the work machine travels along a predetermined target path;
determining a traveling direction status indicating a forward or rearward traveling direction of the work machine; and
setting the steering angle to a neutral angle upon determining that the traveling direction status is unknown during the automatic steering control.

8. The method according to claim 7, further comprising:
acquiring a command signal usable to instruct the forward or rearward traveling direction of the work machine;
acquiring a vehicle speed of the work machine; and
determining the traveling direction status based on the command signal and the vehicle speed.

9. The method according to claim 8, further comprising:
in a case in which the traveling direction status is forward travel, determining that the traveling direction status is unknown when the command signal indicates an instruction other than forward travel and the vehicle speed is less than a predetermined threshold.

10. The method according to claim 8, further comprising:
in a case in which the traveling direction status is rearward travel, determining that the traveling direction status is unknown when the command signal indicates an instruction other than rearward travel and the vehicle speed is less than a predetermined threshold.

11. The method according to claim 7, further comprising:
maintaining the steering angle at the neutral angle until the traveling direction status is determined as forward travel or rearward travel.

12. The method according to claim 7, further comprising:
acquiring a command signal instructing the forward or rearward traveling direction of the work machine; and
maintaining the steering angle at the neutral angle until a predetermined time period has elapsed upon determining that the traveling direction status is unknown when a switch of the traveling direction is instructed based on the command signal.

13. A method for controlling a work machine, the method comprising:
executing an automatic steering control to control a steering angle of the work machine so that the work machine travels along a predetermined target path;
determining a traveling direction status indicating a forward or rearward traveling direction of the work machine; and
setting the steering angle to a neutral angle when the forward or rearward traveling direction of the work machine is switched during the automatic control.
